(19) United States
(12) Patent Application Publication
(10) Pub. No.: US 2011/0288193 A1
(43) Pub. Date: Nov. 24, 2011

(54) Method for Producing Moulded Parts Containing Polybutadiene

(75) Inventors: Heike Kloppenburg, Dusseldorf (DE); Alex Lucassen, Dormagen (DE); David Hardy, Dormagen (DE); Jochen Kroll, Bergisch Gladbach (DE); Alexander Lissy, Leverkusen (DE); Dino Tebling, Wermelskirchen (DE)

(73) Assignee: LANXESS DEUTSCHLAND GMBH, Leverksuen (DE)

(21) Appl. No.: 13/124,746

(22) PCT Filed: Oct. 23, 2009
(86) PCT No.: PCT/EP2009/063954

§ 371 Date: Aug. 10, 2011

(30) Foreign Application Priority Data
Oct. 30, 2008 (DE) 10 2008 053 888.4

(51) Int. Cl. C08L 9/00; C08K 5/09; C08K 5/098

(52) U.S. Cl. 521/150; 524/571; 524/397; 524/284

(57) ABSTRACT

The present invention relates to a novel process for the production of polybutadiene-containing mouldings.

The present invention relates to a novel process for the production of polybutadiene-containing mouldings.

Polybutadiene-containing mouldings are mainly used in the tyre industry as former strip for sidewalls or treads. A decisive factor here is that the surface of these is smooth and that the number of indentations at their edges has been minimized.

Polybutadienes with high cis content and with minimum polydispersity are known to provide excellent properties in tyre mixtures, e.g. low rolling resistance or low tyre abrasion. Polydispersity is generally determined by gel-permeation chromatography, being the quotient obtained by dividing weight-average molar mass Mw by number-average molar mass Mn, thus representing the breadth of distribution of the molar masses.

As described inter alia in S. L. Agrawal et al., Rubber World—Akron, 2005, Vol. 232/3, pages 17 to 19 and 56, broad polydispersity advantageously affects processing performance, whereas narrow polydispersity advantageously affects the service properties of the rubber. According to Jochen Schnetger, Lexikon der Kautschuktechnologie [Rubber technology encyclopaedia], Hüthig Verlag Heidelberg, 3rd Edition, 2003, page 319, a broad distribution of the molar masses leads to good processing performance of the rubbers and rubber mixtures, apparent inter alia in relatively low mixture viscosity, relatively low mixing time and relatively low extrusion temperatures. For this reason, a polybutadiene with broad molar mass distribution is often used, giving an improvement in processability but having a disadvantageous effect on the property profile of the tyre.

Accordingly, the processing of the abovementioned polybutadienes with narrow polydispersity in the mixture is difficult. If these mixtures are processed at the conventional high temperatures which are mostly above 90° C., extrusion speed has to be reduced drastically in order to obtain an acceptable extrudate quality, and this reduces the cost-effectiveness of the process.

It was therefore an object to provide a novel cost-effective process for the production of polybutadiene-containing mouldings which does not have the disadvantages of the prior art.

It has now been found that low extrusion temperatures have a favourable effect on the surface characteristic of the mixtures, and this is all the more surprising because it is generally only higher temperatures that improve properties, for example in the case of cobalt-catalysed polybutadiene.

The present invention therefore provides a process for the production of polybutadiene-containing mouldings, characterized in that at least one polybutadiene with cis content greater than 95%, preferably greater than 96%, and polydispersity smaller than 2.5 is mixed with at least one filler and with at least one processing aid and then extruded at temperatures of from 40 to 75° C. preferably from 40 to 55° C.

The polybutadienes used with cis content (1,4-cis content) greater than 95%, preferably greater than 96%, and with polydispersity smaller than 2.5, particularly preferably in the range from 1.7 to 2.2, are preferably those which have 1,2-vinyl content smaller than 1%, preferably smaller than 0.8%, and Mooney viscosity ML 1+4 at 100° C. of from 35 to 80 Mooney units, preferably in the range from 40 to 75 Mooney units. Those used are preferably neodymium-catalysed polybutadienes (catalysed by neodymium-containing systems). These involve commercially obtainable products. By way of example, these can be produced according to EP-A 11 184 and EP-A 7027, using neodymium-containing catalysts.

The term neodymium-containing catalysts includes Ziegler-Natta catalysts based on neodymium compounds, these being soluble in hydrocarbons. It is particularly preferable to use neodymium carboxylates, in particular neodymium neodecanoate, neodymium octanoate, neodymium naphthenate, neodymium 2,2-diethylhexanoate and/or neodymium 2,2-diethylheptanoate. When these catalysts are used in the polymerization of, for example, butadiene, they give, in very high yields and with high selectivity, a polybutadiene which particularly features a high proportion of 1,4-cis units.

In one embodiment of the process according to the invention, the filler used comprises carbon black and/or silica.

Fillers that can be used are any of the known fillers used in the rubber industry. These encompass both active and inert fillers.

Examples that may be mentioned are:
fine-particle silicas, produced by way of example via precipitation from solutions of silicates, or flame hydrolysis of silicon halides with specific surface areas of from 5 to 1000m²/g (BET surface area), preferably from 20 to 400 m²/g, and with primary particle sizes of from 10 to 400 nm. The silicas can, if appropriate, also take the form of mixed oxides with other metal oxides, such as oxides of Al, of Mg, of Ca, of Ba, of Zn, of Zr, or of Ti;
synthetic silicates, such as aluminium silicate, or alkaline earth metal silicate, e.g. magnesium silicate or calcium silicate, with BET surface areas of from 20 to 400 m²/g and with primary particle diameters of from 10 to 400 nm;
natural silicates, such as kaolin and any other naturally occurring form of silica;
glass fibres and glass-fibre products (mats, strands), or glass microbeads;
metal oxides, such as zinc oxide, calcium oxide, magnesium oxide, or aluminium oxide;
metal carbonates, such as magnesium carbonate, calcium carbonate, or zinc carbonate;
metal hydroxides, e.g. aluminium hydroxide or magnesium hydroxide;
metal salts, e.g. the zinc or magnesium salts of α,β-unsaturated fatty acids, e.g. acrylic or methacrylic acid, having from 3 to 8 carbon atoms, examples being zinc acrylate, zinc diacrylate, zinc methacrylate, zinc, dimethacrylate and mixtures thereof;
carbon blacks: the carbon blacks to be used here are carbon blacks produced by the flame-black process, channel-black process, furnace-black process, gas-black process, thermal-black process, or acetylene-black process, or arc processes, their BET surface areas being from 9 to 200 m²/g, e.g. the following carbon blacks: SAF-, ISAF-LS, ISAF-HM, ISAF-LM, ISAF-HS, CF, SCF, HAF-LS, HAF, HAF-HS, FF-HS, SPF, XCF, FEF-LS, FEF, FEF-HS, GPF-HS, GPF, APF, SRF-LS, SRF-LM, SRF-HS, SRF-HM and MT, or the following carbon blacks in accordance with ASTM: N110, N219, N220, N231, N234, N242, N294, N326, N327, N330, N332, N339, N347, N351, N356, N358, N375, N472, N539, N550, N568, N650, N660, N754, N762, N765, N774, N787 and N990;
rubber gels, in particular those based on polybutadiene, butadiene-styrene copolymers, butadiene-acrylonitrile copolymers and polychloroprene.

Fillers preferably used are fine-particle silicas, carbon blacks and/or zinc salts of acrylic or methacrylic acid.

The fillers mentioned can be used alone or in a mixture. In one particularly preferred embodiment, the filler used comprises a mixture composed of pale-coloured fillers, such as fine-particle silicas, and of carbon blacks, the mixing ratio of pale-coloured fillers to carbon blacks being from 0.05 to 20, preferably from 0.1 to 15.

The amounts used here of the fillers are preferably in the range from 10 to 500 parts by weight of filler, based on 100 parts by weight of rubber. It is particularly preferable to use from 20 to 200 parts by weight.

In addition to the polybutadienes, mentioned, other rubbers can also be used, examples being natural rubber, or else other synthetic rubbers. The amount of these is usually in the range from 0.5 to 85% by weight, preferably from 10 to 70% by weight, based on the entire amount of rubber in the rubber mixture. The amount of additionally added rubbers depends again on the respective intended use.

Synthetic rubbers known from the literature are listed here by way of example. They encompass inter alia
BR—polybutadiene,
IR—polyisoprene,
SBR—styrene-butadiene copolymers having styrene contents of from 1 to 60% by weight, preferably from 20 to 50% by weight,
IIR—isobutylene-isoprene copolymers,
ABR—butadiene-C₁₋₄-alkyl acrylate copolymers,
CR—polychloroprene,
NBR—butadiene-acrylonitrile copolymers having acrylonitrile contents of from 5 to 60% by weight, preferably from 10 to 40% by weight,
HNBR—partially hydrogenated or fully hydrogenated NBR rubber,
EPDM—ethylene-propylene-diene terpolymers,
   and also mixtures of these rubbers. Materials of interest for the production of motor vehicle tyres are more particularly natural rubber, emulsion SBR, and also solution SBR, with a glass transition temperature above −50° C., polybutadiene rubber with high cis content (>90%), and also polybutadiene rubber having vinyl content of up to 80%, and also mixtures of these. Commercially available starting materials are involved here.

For the purposes of the invention, processing aids include by way of example substances which serve for the crosslinking of the rubber mixtures (crosslinking agents), or which improve the physical properties of the resultant vulcanizates for their specific intended purpose.

Crosslinking agents used in particular comprise sulphur or sulphur-donor compounds. Examples of suitable crosslinking chemicals are organic peroxides, e.g. dicumyl peroxide, tert-butyl cumyl peroxide, bis(tert-butylperoxyisopropyl)benzene, di-tert-butyl peroxide, dibenzoyl peroxide, bis(2,4-dichlorobenzoyl) peroxide, tert-butyl perbenzoate, and also organic azo compounds, such as azobisisobutyronitrile and azobiscyclohexanonitrile, and also di- and polymercapto compounds, such as dimercaptoethane, 1,6-dimercaptohexane, 1,3,5-trimercaptotriazine, and mercapto-terminated polysulphide rubbers, e.g. mercapto-terminated reaction products of bischloroethyl formal with sodium polysulphide. It is moreover possible as mentioned to use further processing aids, such as the known reaction accelerators, antioxidants, heat stabilizers, light stabilizers, antiozonants, processing aids, plasticizers, tackifiers, blowing agents, dyes, pigments, waxes, extenders, e.g. DAE (distillate aromatic extract) oil, TDAE (treated distillate aromatic extract) oil, MES (mild extraction solvates) oil, RAE (residual aromatic extract) oil, TRAE (treated residual aromatic extract) oil, naphthenic and heavy naphthenic oils, organic acids, retardants, metal oxides, and also activators.

Preferred processing aids used are reaction accelerators, antioxidants, antiozonants, extenders, e.g. the conventional naphthenic, aromatic or aliphatic extender oils, organic acids, e.g. stearic acid, retarders, metal oxides, such as zinc oxide, and also activators, e.g. silanes.

The amount of processing aid is preferably in the range from 0.1 to 20%, based on the rubber used, and depends on the desired property profile of the mixtures.

The mixtures can by way of example be produced via blending of the rubbers with filler and with the further mixing constituents in or on suitable mixing apparatuses, e.g. kneaders, rolls or extruders.

For use of the mixtures by way of example in the tyre industry, or in the production of technical rubber products or in the golf-ball industry, the mixtures are used to produce mouldings, mostly in the form of extrudates, profiles or former strips. The mouldings can by way of example be produced in suitable apparatuses such as extruders or calenders.

The temperature during the said processing depends on the rubbers used. When 100 phr of polybutadiene according to the invention are used, the preferred temperature is from 40 to 55° C. In the mixture with, for example, styrene-butadiene rubber, the temperature is preferably from 50 to 75° C., depending on the proportion of the styrene-butadiene rubber. The meaning of 1 phr here is 1 g of substance, based on 100 g of polymer.

The necessary temperature is mostly achieved by using mechanical energy, where the mixture is, by way of example, kneaded along a relatively long path within the interior of a screw-based extruder, and is thus heated. The shaping process mostly uses a die, through which the heated mixture is forced. The preferred intention is that the mouldings are dimensionally stable, have a smooth surface, and have no indentations at the sides or corners.

The quality of the resultant mouldings here is preferably assessed using the Garvey die to DIN 2230-96 in an extrusion test.

The processing of the polybutadienes according to the invention with polydispersity smaller than 2.5 is found to be very easy and to give smooth surfaces on the mouldings, when the processing temperature is lowered, as a function of the proportion of the polybutadiene, to from 40 to 75° C., or in the case of mixtures without further rubber components, to values below 55° C. This process permits utilization of the favourable properties of these narrowly distributed polybutadienes, e.g. markedly reduced rolling resistance, markedly improved rebound resilience or markedly lower abrasion when comparison is made with other polybutadienes, good processing, for example in various mixtures for tyre technology, in the golf-ball industry or for the production of technical rubber products.

The examples below serve to illustrate the invention, but with no resultant limiting effect.

### EXAMPLE

Rubber mixtures were produced comprising BUNA™ CB 22 and BUNA™ CB 25 as Nd-catalysed polybutadienes, and also, for comparison, TAKTENE® 220 and TAKTENE® 221 as co-polybutadiene. The analytical results for the polybutadienes are stated in Table 1. Table 2 lists the constituents of the mixtures. The mixtures were initially produced without sulphur and accelerator in a 1.5 l kneader. The mixture constituents sulphur and accelerator were then admixed on a roll at 40° C.

TABLE 1
Analytical results for the polybutadienes

| | TAKTENE ® | TAKTENE ® | BUNA ™ | BUNA ™ |
|---|---|---|---|---|
| | 220 | 221 | CB 25 | CB 22 |
| 1,4-cis | 96.5 | 98.0 | 97.8 | 98.2 |
| content in % | | | | |
| 1,2-vinyl | 2.5 | 1.3 | 0.6 | 0.5 |
| content in % | | | | |
| PDI (Mw/Mn) | 3.61 | 3.25 | 2.13 | 1.77 |
| Mw in kg/mol | 327 | 400 | 339 | 359 |
| ML 1 + 4 (100) | 39.2 | 53.7 | 44.2 | 63.9 |

PDI = Polydispersity or polydispersity index

The following substances were used for the studies on the mixtures:

| Trade name | Producer |
|---|---|
| BUNA ™ CB 22 and BUNA ™ CB 25 as | Lanxess Deutschland GmbH |
| Nd polybutadiene | |
| TAKTENE ® 220 and TAKTENE ® 221 | Lanxess Corp. |
| as co-polybutadiene | |
| CORAX N 326 as carbon black | Evonik Degussa GmbH |
| VIVATEC 500 as oil | Hansen und Rosenthal KG |
| ROTSIEGEL ZINC WHITE as zinc oxide | Grillo Zinkoxid GmbH |
| EDENOR C 18 98-100 as Stearic acid | Caldic Deutschland GmbH |
| VULKANOX 4020/LG as stabilizier | Lanxess Deutschland GmbH |
| VULKANOX HS/LG as stabilizer | Lanxess Deutschland GmbH |
| VULKACIT ® CZ/EGC as accelerator | Lanxess Deutschland GmbH |
| RHENOGRAN IS 60-75 as sulphur | RheinChemie Rheinau GmbH |
| ANTILUX 654 as stabilizer | RheinChemie Rheinau GmbH |
| RESIN SP-1068 as tackifier | Schenectady International Inc. |

TABLE 2
Constitution of the mixtures

| | CE1 | CE2 | IE1 | IE2 |
|---|---|---|---|---|
| | CoBR | CoBR | NdBR | NdBR |
| TAKTENE ® 220 | 100 | | | |
| TAKTENE ® 221 | | 100 | | |
| BUNA ™ CB 25 | | | 100 | |
| BUNA ™ CB 22 | | | | 100 |
| CORAX N 326 | 50 | 50 | 50 | 50 |
| VULKANOX 4020/LG | 2 | 2 | 2 | 2 |
| VULKANOX HS/LG | 3 | 3 | 3 | 3 |
| EDENOR C 18 98-100 | 3 | 3 | 3 | 3 |
| VIVATEC 500 | 4 | 4 | 4 | 4 |
| VULKACIT ® CZ/EGC | 1.4 | 1.4 | 1.4 | 1.4 |
| RHENOGRAN IS 60-75 | 2.36 | 2.36 | 2.36 | 2.36 |
| ROTSIEGEL ZINC WHITE | 2 | 2 | 2 | 2 |
| RESIN SP-1068 | 3 | 3 | 3 | 3 |
| ANTILUX 654 | 2 | 2 | 2 | 2 |

CE = Comparative Example

To assess surface, an extrudate was produced through the Garvey die from the unvulcanized mixtures of Inventive Examples 1 and 2, and CE1 and CE2, and studied. The extrusion test was carried out using a Brabender miniature extruder with a Garvey die of dimensions 16 mm/10 d. The quality of the surface was evaluated to DIN 2230-96, Rating System B. Profile quality from A8 to A10 is evaluated as good, and quality from C3 to E1 is evaluated as poor. However, the evaluation can also be carried out on the basis of the figures, without any rating system.

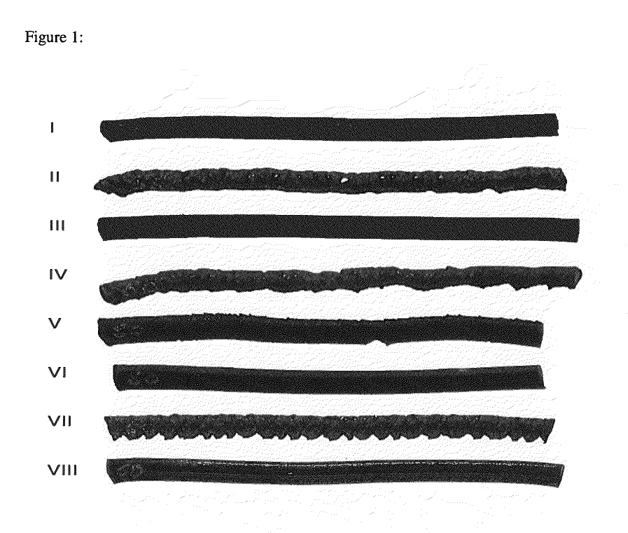

FIG. 1 depicts the surface quality recorded for the extruded mouldings, the abbreviations used here being as follows:
I: Comparative Example CE1 at 90° C.
II: Comparative Example CE1 at 55° C.
III: Comparative Example CE2 at 90° C.
IV: Comparative Example CE2 at 55° C.
V: Inventive Example 1 at 90° C.
VI: Inventive Example 1 at 55° C.
VII: Inventive Example 2 at 90° C.
VIII: Inventive Example 2 at 55° C.

For 90° C., the temperature of the barrel was controlled to 90° C. and that of the die was controlled to 105° C. For 55° C., the temperature of the barrel and die was controlled at 55° C.

It can be seen that for 90° C. the surface quality of the extruded mouldings (I and III) in the Comparative Examples CE1 and CE2 is substantially smoother, with rating A9, than for 55° C. (II and IV), with rating from C3 to D2. In Inventive Examples 1 and 2, the polybutadienes exhibit a smoother surface of the mouldings for 55° C. (VI and VIII), with rating from A8 to A9, than for 90° C. (V and VII), with rating from C3 to D2.

The figures clearly show the good effect of the low temperature on the surface profile of the mixtures according to Inventive Examples 1 and 2. Use of cis-polybutadienes with polydispersity smaller than 2.5 can combine vulcanizate properties which are very good in comparison with other polybutadienes, e.g. markedly reduced rolling resistance, improved rebound resilience or reduced abrasion, with simple production of mouldings with a smooth surface, if the processing temperature is lowered, as a function of the proportion of the said polybutadienes, to from 40 to 75° C., or in the case of mixtures without further rubber components, to values below 55° C.

The lower temperature permits by way of example extrusion of mixtures using Nd-catalysed polybutadienes at the same high speed usually used at the higher temperatures for other mixtures, and this underlines the quality of the process according to the invention.

What is claimed is:

1. Process for the production of polybutadiene-containing mouldings, characterized in that at least one polybutadiene with cis content greater than 95% and polydispersity smaller than 2.5 is mixed with at least one filler and with at least one processing aid and then extruded at temperatures of from 40 to 75° C.

2. Process according to claim 1, characterized in that the polybutadiene used comprises a polybutadiene catalysed by neodymium-containing systems.

3. Process according to claim 1 or 2, characterized in that the filler used comprises fine-particle silica, carbon black and/or zinc salts of acrylic or methacrylic acid.

4. Process according to one or more of claims 1 to 3, characterized in that the processing aid used comprises crosslinking agents, reaction accelerators, antioxidants, heat stabilizers, light stabilizers, antiozonants, processing aids, plasticizers, tackifiers, blowing agents, dyes, pigments, waxes, extenders, organic acids, retardants, and/or metal oxides, and/or activators.

5. Process according to one or more of claims 1 to 4, characterized in that further synthetic rubbers are also used, examples being polybutadienes, styrene-butadiene rubbers and/or natural rubbers.
